(19) United States
(12) Patent Application Publication
(10) Pub. No.: US 2025/0239193 A1
(43) Pub. Date: Jul. 24, 2025

(54) DISPLAY DEVICE AND METHOD OF DRIVING SAME

(71) Applicant: LG Display Co., Ltd., Seoul (KR)

(72) Inventors: Moo Kyoung HONG, Paju-si (KR); Sin Kyun PARK, Paju-si (KR)

(73) Assignee: LG Display Co., Ltd., Seoul (KR)

(21) Appl. No.: 18/965,648

(22) Filed: Dec. 2, 2024

(30) Foreign Application Priority Data
Jan. 19, 2024 (KR) 10-2024-0008829

(51) Int. Cl. G09G 3/00; G09G 3/3233

(52) U.S. Cl. CPC G09G 3/006; G09G 3/3233; G09G 2300/0413; G09G 2300/0842; G09G 2320/046; G09G 2330/04; G09G 2330/12

(57) ABSTRACT

A display device can include a display panel including subpixels disposed in a display area and dummy subpixel lines disposed in an outer area of the display area, and a circuit configured to output a data voltage for driving the display panel during a first period and acquire a sensing value from the display panel during a second period, and in response to a change of a driving frequency of the display panel, increase or decrease a number of sensing target dummy subpixel lines among the dummy subpixel lines to sense during the second period.

### CROSS-REFERENCE TO RELATED APPLICATIONS

This application claims priority to Korean Patent Application No. 10-2024-0008829, filed in the Republic of Korea, on Jan. 19, 2024, the entirety of which is hereby incorporated by reference into the present application as if fully set forth herein.

### BACKGROUND

### Field

The present disclosure relates to a display device and a method of driving the same.

### Discussion of the Related Art

As information technology develops, the market for display devices, which are communication media between users and information, is growing. Accordingly, display devices such as a light emitting display (LED) device, a quantum dot display (QDD) device, and a liquid crystal display (LCD) device are increasingly used.

The display devices described above include a display panel including subpixels, a driver outputting driving signals for driving the display panel, and a power supply for generating power to be supplied to the display panel or the driver.

In such display devices, when driving signals, for example, a scan signal and a data signal, are supplied to subpixels formed in a display panel, selected subpixels transmit light or directly emit light, thereby displaying an image.

However, as display devices have higher resolutions and high driving frequencies, it can be difficult to secure enough sensing time for performing compensation operations (e.g., difficulty in sensing during a short blank period while a display panel is driven). In addition, there exists a need to be able to detect the presence or absence of defects in the display panel based on different driving conditions.

### SUMMARY OF THE DISCLOSURE

Accordingly, the present disclosure is directed to a display device and a method of driving the same that substantially obviate one or more problems due to limitations and disadvantages of the related art.

An object of the present disclosure is to solve the problem of securing enough sensing time (e.g., difficulty in sensing during a short blank period while a display panel is driven) that can occur in a high-resolution and high-frequency driving environment. In addition, an object of the present disclosure is to detect presence or absence of defects in the display panel by dynamically increasing or decreasing the number of sensing target dummy subpixels to sense during a sensing period, in response to a change in a driving frequency during orbital driving of the display panel.

Additional advantages, objects, and features of the present disclosure will be set forth in part in the description which follows and in part will become apparent to those having ordinary skill in the art upon examination of the following or can be learned from practice of the present disclosure. The objectives and other advantages of the present disclosure can be realized and attained by the structure particularly pointed out in the written description and claims hereof as well as the appended drawings.

To achieve these objects and other advantages and in accordance with the purpose of the present disclosure, as embodied and broadly described herein, a display device includes a display panel including subpixels disposed in a display area and dummy subpixel lines disposed in an outer area, and a circuit configured to output a data voltage for driving the display panel during a first period and acquire a sensing value from the display panel during a second period, in which the circuit increases or decreases the number of sensing target dummy subpixel lines among the dummy subpixel lines in response to a driving frequency of the display panel.

The circuit can increase the number of sensing target dummy subpixel lines as the driving frequency increases.

The circuit can set a reference driving frequency of the display panel, increase the number of sensing target dummy subpixel lines when the driving frequency becomes higher than the reference driving frequency, and decrease the number of sensing target dummy subpixel lines when the driving frequency becomes lower than the reference driving frequency.

The circuit can define a dummy subpixel line displaying black during a blank period of the display panel as a sensing target when a position of an image displayed on the display panel moves up, down, left, or right.

The circuit can determine whether the display panel has a defect based on the sensing value obtained from the sensing target dummy subpixel line.

The circuit can apply a sensing data voltage through a dummy data line connected to the dummy subpixel line during the blank period of the display panel, and acquire the sensing value through a reference line connected to the dummy subpixel line.

In another aspect of the present disclosure, a method of driving a display device includes displaying a protection image based on subpixels disposed in a display area of a display panel and moving a position where the protection image is displayed, displaying a black image on at least one of dummy subpixel lines disposed in an outer area of the display panel and moving a position of the black image whenever the display position of the protection image is moved, and defining a dummy subpixel line displaying black among the dummy subpixel lines as a sensing target when the position of the image displayed on the display panel moves up, down, left, or right, and sensing sensing target dummy subpixel lines while varying the number of sensing target dummy subpixel lines in response to a driving frequency of the display panel.

The sensing of the sensing target dummy subpixel lines can include increasing the number of sensing target dummy subpixel lines as the driving frequency of the display panel increases.

The method can further include determining whether the display panel has a defect based on a sensing value obtained from the sensing target dummy subpixel line.

The sensing of the sensing target dummy subpixel lines can be performed during a blank period of the display panel.

It is to be understood that both the foregoing general description and the following detailed description of the present disclosure are exemplary and explanatory and are intended to provide further explanation of the present disclosure as claimed.

### BRIEF DESCRIPTION OF THE DRAWINGS

The accompanying drawings, which are included to provide a further understanding of the present disclosure and are incorporated in and constitute a part of this application, illustrate embodiment(s) of the present disclosure and together with the description serve to explain the principle of the present disclosure. In the drawings:

FIG. 1 is a block diagram schematically showing a light emitting display device according to an embodiment of the present disclosure, FIG. 2 is a configuration diagram schematically showing a subpixel shown in FIG. 1 according to an embodiment of the present disclosure, and FIG. 3 is a diagram illustrating a pixel composed of subpixels according to an embodiment of the present disclosure;

FIG. 4 and FIG. 5 are diagrams illustrating the configuration of a gate-in-panel type gate driver according to embodiments of the present disclosure, and FIG. 6 is a diagram showing an example of the arrangement of the gate-in-panel type gate driver according to an embodiment of the present disclosure;

FIG. 7 is a diagram schematically showing a subpixel and a data driver according to an embodiment of the present disclosure, FIG. 8 is a diagram schematically showing a subpixel and a data driver according to another embodiment of the present disclosure, and FIG. 9 is a waveform diagram illustrating a sensing period and a display period according to an embodiment of the present disclosure;

FIG. 10 is a diagram showing some of components included in the data driver according to an embodiment of the present disclosure in more detail, and FIG. 11 and FIG. 12 are diagrams showing a method of sensing a display panel according to an embodiment of the present disclosure;

FIG. 13 is a diagram illustrating a dummy pixel group included in a display panel of a light emitting display device according to an embodiment of the present disclosure, and FIG. 14 to FIG. 16 are diagrams illustrating an orbit driving method of the display panel according to an embodiment of the present disclosure;

FIG. 17 to FIG. 20 are diagrams illustrating a method of sensing one dummy subpixel included in a display panel at a first frequency according to an embodiment of the present disclosure, and FIG. 21 to FIG. 24 are diagrams illustrating a method of sensing a plurality of dummy subpixels included in a display panel at a second frequency according to an embodiment of the present disclosure;

FIG. 25 to FIG. 27 are diagrams illustrating change in driving timing when an adaptive sensing method is used in response to change in a frequency according to an embodiment of the present disclosure; and

FIG. 28 is a flowchart illustrating a method of driving a light emitting display device according to an embodiment of the present disclosure.

### DETAILED DESCRIPTION OF THE EMBODIMENTS

Advantages and features of the present specification and methods of achieving them will become apparent with reference to embodiments, which are described in detail, in conjunction with the accompanying drawings. However, the present specification is not limited to the embodiments to be described below and can be implemented in different forms, the embodiments are only provided to completely disclose the present disclosure and completely convey the scope of the present disclosure to those skilled in the art, and the present specification is only defined by the disclosed claims.

Since the shapes, sizes, proportions, angles, numbers, and the like disclosed in the drawings for describing the embodiments of the present disclosure are only exemplary, the present disclosure is not limited to the illustrated items. The same reference numerals indicate the same components throughout the specification. Further, in describing the present disclosure, when it is determined that a detailed description of related known technology can unnecessarily obscure the gist of the present disclosure, the detailed description thereof will be omitted.

When “including,” “having,” “consisting,” and the like mentioned in the present specification are used, other parts can be added unless “only” is used. A situation in which a component is expressed in a singular form includes a plural form unless explicitly stated otherwise.

In interpreting the components, it should be understood that an error range is included even when there is no separate explicit description.

In the situation of a description of a positional relationship, for example, when the positional relationship of two parts is described as “on,” “at an upper portion,” “at a lower portion,” “next to,” and the like, one or more other parts can be located between the two parts unless “immediately” or “directly” is used.

Although first, second, and the like are used to describe various components, these components are not limited by these terms. These terms are only used to distinguish one component from another. Accordingly, a first component, which is mentioned, below can also be a second component within the technical spirit of the present disclosure. Also, the term “can” includes all meanings and definitions of the word “may.”

The same reference numerals can refer to substantially the same elements throughout the present disclosure.

The following embodiments can be partially or entirely bonded to or combined with each other and can be linked and operated in technically various ways. The embodiments can be carried out independently of or in association with each other.

Hereinafter, various embodiments of the present disclosure will be described in detail with reference to the accompanying drawings.

A display device according to embodiments of the present disclosure can be implemented as a television system, an image player, a personal computer (PC), a home theater, an automobile electric device, a smartphone, or the like, but is not limited thereto. The display device according to the present disclosure can be implemented as a light emitting display (LED) device, a quantum dot display (QDD) device, a liquid crystal display (LCD) device, or the like. However, for convenience of description, as an example, a light emitting display device that directly emits light based on inorganic light emitting diodes or organic light emitting diodes will be described below.

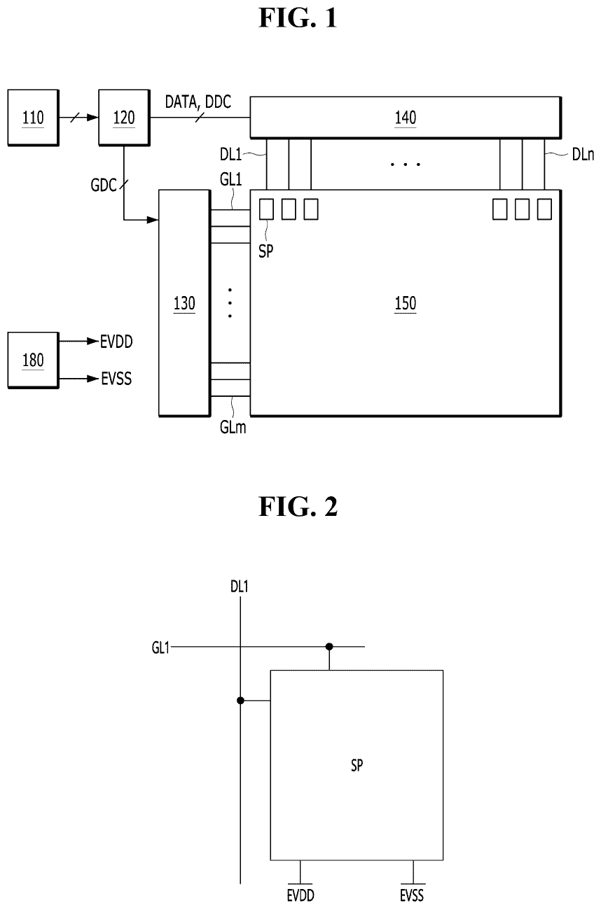

FIG. 1 is a block diagram schematically showing a light emitting display device according to an embodiment of the present disclosure, FIG. 2 is a configuration diagram schematically showing a subpixel shown in FIG. 1 according to an embodiment of the present disclosure, and FIG. 3 is a diagram showing a pixel composed of subpixels according to an embodiment of the present disclosure.

As illustrated in FIG. 1, FIG. 2, and FIG. 3, the light emitting display device can include a timing controller 120, a gate driver 130, a data driver 140, a display panel 150, a power supply 180, and the like.

An image provider 110 (e.g., a set or a host system) can output various driving signals along with an externally supplied image data signal or an image data signal stored in an internal memory. The image provider 110 can supply data signals and various driving signals to the timing controller 120.

The timing controller 120 can output a gate timing control signal GDC for controlling the operation timing of the gate driver 130, a data timing control signal DDC for controlling the operation timing of the data driver 140, and various synchronization signals. The timing controller 120 can supply a data signal DATA supplied from the image provider 110 to the data driver 140 along with the data timing control signal DDC. The timing controller 120 can be implemented in the form of an integrated circuit (IC) and mounted on a printed circuit board, but is not limited thereto.

The gate driver 130 can output a gate signal (or a gate voltage) in response to the gate timing control signal GDC supplied from the timing controller 120. The gate driver 130 can supply gate signals to subpixels included in the display panel 150 through gate lines GL1 to GLm. The gate driver 130 can be implemented in the form of an IC or directly formed on the display panel 150 in a gate-in-panel structure, but is not limited thereto.

The data driver 140 can sample and latch the data signal DATA in response to the data timing control signal DDC supplied from the timing controller 120, convert the digital data signal into an analog data voltage based on a gamma reference voltage, and output the analog data voltage. The data driver 140 can supply data voltages to the subpixels included in the display panel 150 through data lines DL1 to DLn. The data driver 140 can be implemented in the form of an integrated circuit (IC) and mounted on the display panel 150 or mounted on a printed circuit board, but is not limited thereto.

The power supply 180 can generate first power at a high level and second power at a low level based on an external input voltage supplied from the outside. The power supply 180 can output the first power through a first power line EVDD and output the second power through a second power line EVSS. The power supply 180 can generate and output voltages (e.g., a scan high voltage and a scan low voltage) to drive the gate driver 130 and voltages (e.g., a drain voltage and a half drain voltage) to drive the data driver 140 as well as the first power and the second power.

The display panel 150 can display an image in response to driving signals including a scan signal and a data voltage, the first power, and the second power. The subpixels of the display panel 150 can directly emit light. The display panel 150 can be manufactured based on a substrate having rigidity or flexibility, such as glass, silicon, polyimide, or the like. For example, one subpixel SP can be connected to the first data line DL1, the first gate line GL1, the first power line EVDD, and the second power line EVSS and can include a pixel circuit including a switching transistor, a driving transistor, a capacitor, an organic light emitting diode, etc.

Subpixels SP used in the light-emitting display device directly emit light, and thus the circuit configuration thereof can be complicated. In addition, there are various compensation circuits that compensate for deterioration (e.g., in the threshold voltage, mobility, etc.) of not only the organic light emitting diode emitting light but also the driving transistor that supplies a driving current to drive the organic light emitting diode. Therefore, the subpixel SP is simply shown in the form of a block.

Subpixels emitting light can be composed of red, green, and blue pixels or red, green, blue, and white pixels. For example, one pixel P can include a red subpixel SPR connected to the first data line DL1, a white subpixel SPW connected to the second data line DL2, a green subpixel SPG connected to the third data line DL3, and a blue subpixel SPB connected to the fourth data line DL4. Additionally, the red subpixel SPR, white subpixel SPW, green subpixel SPG, and blue subpixel SPB can be commonly connected to a first reference line VREF1. The first reference line VREF1 can be used to sense deterioration of elements included in one of the red subpixel SPR, white subpixel SPW, green subpixel SPG, and blue subpixel SPB, which will be described below.

Meanwhile, the timing controller 120, the gate driver 130, and the data driver 140 have been described as individual components. However, depending on the implementation method of the light emitting display device, one or more of the timing controller 120, the gate driver 130, and the data driver 140 can be integrated into a single IC. In addition, the timing controller 120, the gate driver 130, the data driver 140, the power supply 180, and the display panel 150 are an assembly for displaying images and can be defined as a display module.

In addition, as an example, the pixels P in which the red subpixel SPR, white subpixel SPW, green subpixel SPG, and blue subpixel SPB are arranged in order has been illustrated. However, the arrangement order and direction of subpixels can vary depending on the implementation method of the light emitting display device.

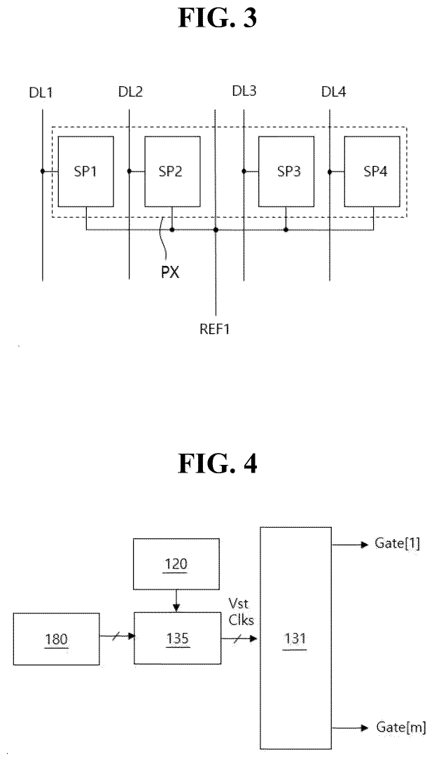

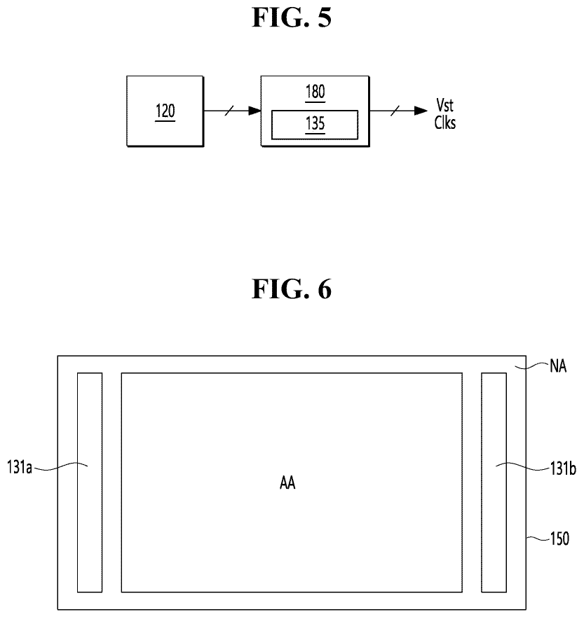

FIG. 4 and FIG. 5 are diagrams illustrating the configuration of a gate-in-panel type gate driver according to embodiments of the present disclosure, and FIG. 6 is a diagram showing an example of the arrangement of the gate-in-panel type gate driver according to an embodiment of the present disclosure.

As shown in FIG. 4, the gate-in-panel type gate driver can include a shift register 131 and a level shifter 135. The level shifter 135 can generate driving clock signals Clks and a start signal Vst based on signals and voltages output from the timing controller 120 and the power supply 180.

The shift register 131 operates based on signals Clks and Vst output from the level shifter 135, and can output gate signals Gate[1] to Gate[m] for turning on or off transistors formed in the display panel. The shift register 131 can take the form of a thin film on the display panel in a gate-in-panel structure.

As shown in FIG. 4 and FIG. 5, unlike the shift register 131, the level shifter 135 can be formed independently in the form of an IC or can be included in the power supply 180. However, this is merely an example and is not limited to thereto.

As shown in FIG. 6, shift registers 131a and 131b that output gate signals in the gate-in-panel type gate driver can be disposed in a non-display area NA of the display panel 150. As an example, the shift registers 131a and 131b are disposed in the left and right non-display areas NA of the display panel 150, but the shift registers 131a and 131b can also be disposed in upper and lower non-display areas NA of the display panel 150 or can be disposed within a display area AA of the display panel 150.

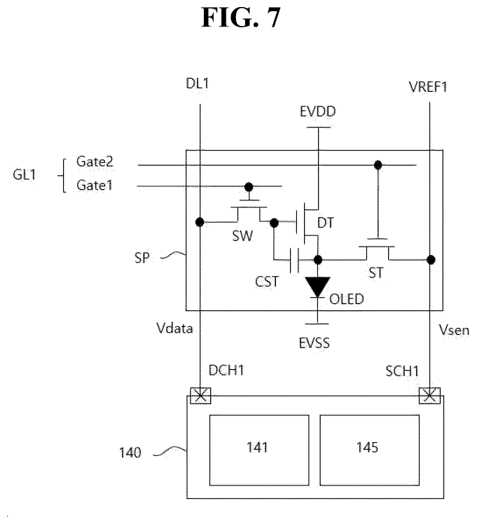

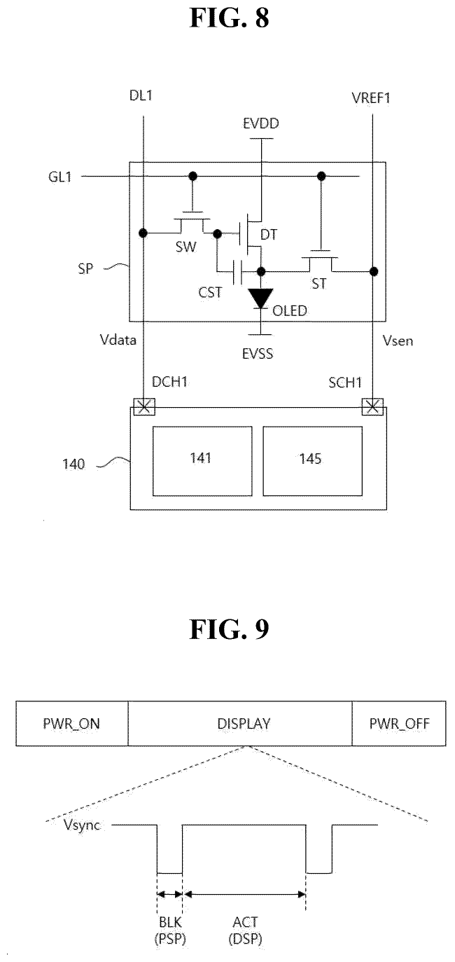

FIG. 7 is a diagram schematically showing a subpixel and a data driver according to a first example of an embodiment of the present disclosure, FIG. 8 is a diagram schematically showing a subpixel and a data driver according to a second example of an embodiment of the present disclosure, and FIG. 9 is a waveform diagram illustrating a sensing period and a display period according to an embodiment of the present disclosure.

As shown in FIG. 7, according to the first example, one subpixel SP can include a switching transistor SW, a driving transistor DT, a sensing transistor ST, a capacitor CST, and an organic light emitting diode OLED.

The driving transistor DT can include a gate electrode connected to a first electrode of the capacitor CST, a first electrode connected to the first power line EVDD, and a second electrode connected to the anode of the organic light emitting diode OLED. The capacitor CST can have the first electrode connected to the gate electrode of the driving transistor DT and a second electrode connected to the anode electrode of the organic light emitting diode OLED. The organic light emitting diode OLED can have the anode connected to the second electrode of the driving transistor DT and a cathode connected to the second power line EVSS.

The switching transistor SW can include a gate electrode connected to a first scan line Gate1 included in the first gate line GL1, a first electrode connected to the first data line DL1, and a second electrode connected to the gate electrode of the driving transistor DT. The sensing transistor ST can include a gate electrode connected to a second scan line Gate2 included in the first gate line GL1, a first electrode connected to the first reference line VREF1, and a second electrode connected to the anode of the organic light emitting diode OLED.

The sensing transistor ST is a type of compensation circuit added to compensate for deterioration of the driving transistor DT or the organic light emitting diode OLED. The sensing transistor ST can enable physical threshold voltage sensing based on the source follower operation of the driving transistor DT. The sensing transistor ST can operate to acquire a sensing voltage Vsen through a sensing node defined between the driving transistor DT and the organic light emitting diode OLED.

According to an embodiment, the data driver 140 can include a driving circuit 141 for driving the subpixel SP and a sensing circuit 145 for sensing the subpixel SP. The driving circuit 141 can be connected to the first data line DL1 through a first data channel DCH1. The driving circuit 141 can output a data voltage Vdata for driving the subpixel SP through the first data channel DCH1.

The sensing circuit 145 can be connected to the first reference line VREF1 through a first sensing channel SCH1. The sensing circuit 145 can acquire a sensing voltage Vsen sensed from the subpixel SP through the first sensing channel SCH1. The sensing circuit 145 can acquire the sensing voltage Vsen based on a current sensing or voltage sensing method.

As shown in FIG. 8, according to the second example, the first gate line GL1 can be integrated into one line. That is, unlike the first example, the first gate line GL1 may not be divided into the first scan line and the second scan line, which can reduce wiring and save space. In this situation, the switching transistor SW and the sensing transistor ST are commonly connected to the first gate line GL1, and thus can be turned on or off at the same time.

As shown in FIG. 9, the light emitting display device according to the embodiment can adopt driving modes respectively corresponding to a first driving period PWR_ON, a second driving period DISPLAY, and a third driving period PWR_OFF when operating to drive the display panel.

The first driving period PWR_ON can correspond to a driving start period in which power is applied to the display panel (e.g., in response to a user input to turn on the display device), the second driving period DISPLAY can correspond to a panel driving period in which operation such as displaying an image is performed after the power is applied to the display panel, and a third driving period PWR_OFF can correspond to a driving end period in which the power applied to the display panel is cut off (e.g., in response to a user input to turn off the display device). Meanwhile, the third driving period PWR_OFF is a period in which the display panel is driven for a certain period of time while displaying black such that the sensing operation of the display panel can be performed. That is, note that the power applied to the display panel and the like is not completely cut off during the third driving period PWR_OFF. In other words, even after receiving an input from the user to power off the display device, the display device can display black to appear off (e.g., give the user the illusion that the device immediately powers off) but remain powered on to carry out sensing operations until finally powering down.

The light emitting display device according to the embodiment can sense the display panel in at least one of the first drive period PWR_ON, the second drive period DISPLAY, and the third drive period PWR_OFF. As an example, in the second driving period DISPLAY, a blank period BLK included in the vertical synchronization signal Vsync can be defined as a sensing period PSP, and an active period ACT included in the vertical synchronization signal Vsync can be defined as a display period DSP.

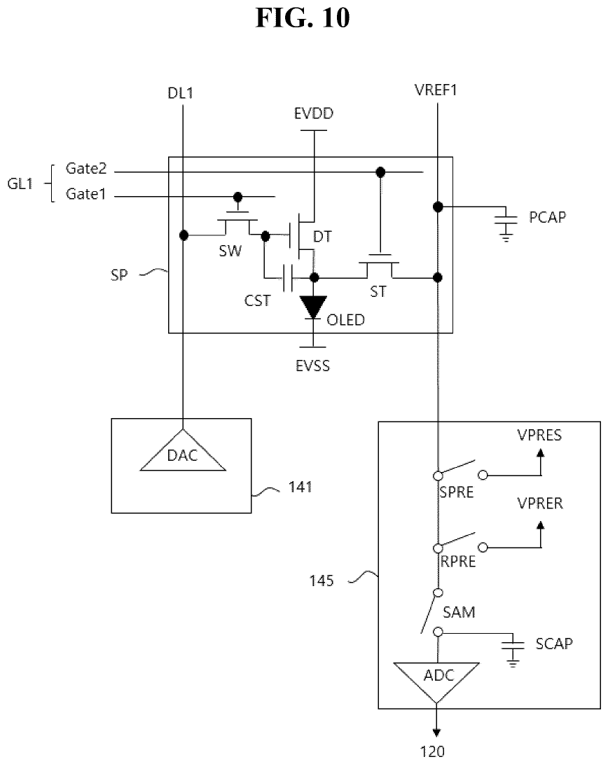

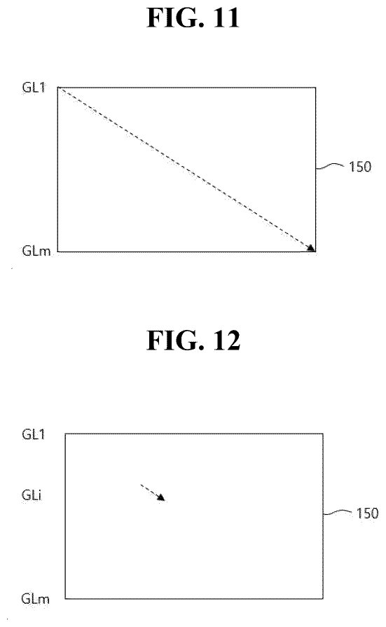

FIG. 10 is a diagram showing some of the components included in the data driver according to an embodiment in more detail, and FIG. 11 and FIG. 12 are diagrams showing a method of sensing the display panel according to the embodiment. Hereinafter, as an example, the structure of the subpixel SP shown in FIG. 7 will be described.

As in the embodiment shown in FIG. 10, the driving circuit 141 can include a digital-to-analog converter DAC to output a sensing data voltage, a black data voltage, or a display data voltage through the first data line DL1. The sensing circuit 145 can include a first voltage circuit SPRE, a second voltage circuit RPRE, a sampling circuit SAM, and an analog-to-digital converter ADC to output and sense a voltage through the first reference line VREF1.

The first voltage circuit SPRE and the second voltage circuit RPRE can perform a voltage output operation to initialize nodes or circuits included in the subpixel SP or charge the same to a specific voltage level. The first voltage circuit SPRE and the second voltage circuit RPRE can include a first reference voltage source VPRES and a second reference voltage source VPRER, respectively. The first voltage circuit SPRE can output a first reference voltage based on the first reference voltage source VPRES, and the second voltage circuit RPRE can output a second reference voltage based on the second reference voltage source VPRER. The first reference voltage can be set to a voltage lower than the second reference voltage (e.g., VPRES<VPRER).

The sampling circuit SAM can perform a sampling operation to acquire a sensing voltage through the first reference line VREF1. For example, the sampling circuit SAM can acquire the sensing voltage from a sensing capacitor PCAP formed on the first reference line VREF1 based on the sensing capacitor PCAP.

The analog-to-digital converter ADC can convert the analog sensing voltage acquired by the sampling circuit SAM into a digital sensing voltage and output the same. For example, the analog-to-digital converter ADC can convert the analog sensing voltage charged in the sensing capacitor PCAP into a digital sensing voltage and output the same.

The timing controller 120 can include a compensator that performs a compensation operation based on a sensing voltage (e.g., sensing data value) supplied from the sensing circuit 145. The compensator included in the timing controller 120 can determine whether the driving transistor DT or the organic light emitting diode OLED included in the subpixel SP has deteriorated based on the sensing voltage and compensate for the deterioration.

As shown in FIG. 11, according to the first example, the light emitting display device can perform a sequential sensing method in which sensing is performed from the first gate line GL1 to the M-th gate line GLm of the display panel 150 (e.g., sensing can be sequentially performed, line by line, for the entire screen). Although FIG. 11 illustrates an example in which sensing is performed sequentially starting from the first gate line GL1, which is the top of the display panel 150, sensing can start from the M-th gate line GLm, which is the bottom of the display panel 150.

As shown in FIG. 12, according to the second example, the light emitting display device can perform a random sensing method in which only an I-th gate line GLi of the display panel 150 is sensed. Although FIG. 12 illustrates an example in which only the I-th gate line GLi, which is one of specific gate lines, is sensed, the sensing target can be two or more gate lines.

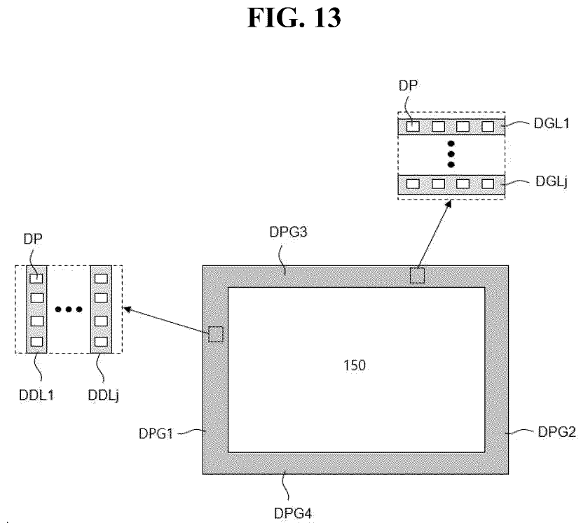

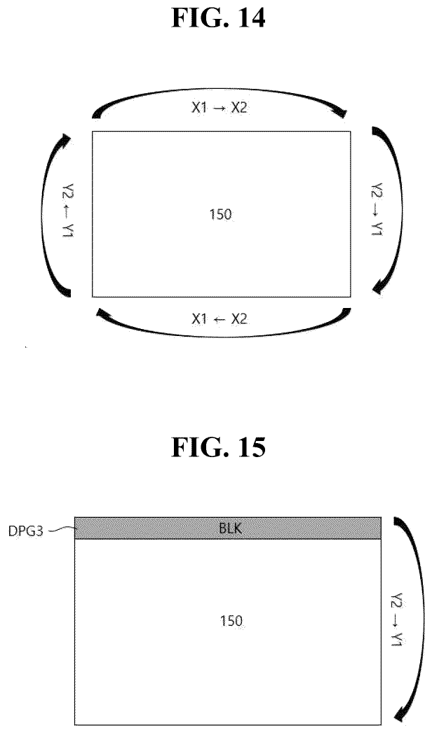

FIG. 13 is a diagram illustrating a dummy pixel group included in a display panel of a light emitting display device according to an embodiment of the present disclosure, and FIG. 14 to FIG. 16 are diagrams illustrating an orbit driving method of the display panel according to an embodiment of the present disclosure.

As shown in FIG. 13, the display panel 150 according to the embodiment can include dummy pixel groups DPG1 to DPG4 disposed in an outer area (or bezel area) of the display area. The dummy pixel groups DPG1 to DPG4 can include a first dummy pixel group DPG1, a second dummy pixel group DPG2, a third dummy pixel group DPG3, and a fourth dummy pixel group DPG4.

The first dummy pixel group DPG1 can be located in the left outer area of the display panel 150 (e.g., left side). The second dummy pixel group DPG2 can be located in the right outer area of the display panel 150 (e.g., right side). The third dummy pixel group DPG3 can be located in the upper outer area of the display panel 150 (e.g., top side). The fourth dummy pixel group DPG4 can be located in the lower outer area of the display panel 150 (e.g., bottom side).

The first dummy pixel group DPG1 can be connected to a first dummy data line DDL1 to a J-th dummy data line DDLj and can include a plurality of dummy subpixels DP disposed in the vertical direction. Here, j can be an integer of 2 or more. Also, the first dummy pixel group DPG1 can be connected to dummy gate lines to perform the same operation as the subpixels disposed in the display area of the display panel 150. In addition, the second dummy pixel group DPG2 located in the outer area opposite to the first dummy pixel group DPG1 can also have the same structure as the first dummy pixel group DPG1.

The third dummy pixel group DPG3 can be connected to the first dummy gate line DGL1 to the J-th dummy gate line DGLj and can include a plurality of dummy subpixels DP disposed in the horizontal direction. Here, j can be an integer of 2 or more. Also, the third dummy pixel group DPG3 can be connected to dummy data lines to perform the same operation as the subpixels disposed in the display area of the display panel 150. In addition, the fourth dummy pixel group DPG4 located in the outer area opposite to the third dummy pixel group DPG3 can also be disposed in the same form as the third dummy pixel group DPG3.

Meanwhile, note that FIG. 13 briefly shows that a dummy pixel group composed of a plurality of dummy subpixels is disposed in each outer area of the display panel 150 according to the embodiment.

As shown in FIG. 14 to FIG. 16, the display panel 150 according to the embodiment can display a specific image (e.g., a screen protection image) rather than a general display image (e.g., the actual image data). In this situation, the position of the displayed image can be moved in the horizontal direction (X1→X2 or X1←X2), vertical direction (Y2←Y1 or Y2→Y1), or horizontal and vertical directions. For example, the screen protection image can be displayed by the dummy pixels and rotated around the border of the screen in an orbit driving manner. The screen protection image can be displayed around the border in a clockwise rotating manner or a counterclockwise rotating manner.

FIG. 15 shows an example in which the position of the display image moves from Y2 to Y1 in the vertical direction of the display panel 150. As shown in FIG. 15, when the position of the display image moves from the top to the bottom, the third dummy pixel group DPG3 located in the upper outer area of the display panel 150 can display a black image BLK. In the opposite situation, the fourth dummy pixel group DPG4 shown in FIG. 13 displays a black image BLK.

FIG. 16 shows an example in which the position of the display image moves from X2 to X1 in the horizontal direction of the display panel 150. As shown in FIG. 16, when the position of the display image moves from right to left, the second dummy pixel group DPG2 located in the right outer area of the display panel 150 can display a black image BLK. In the opposite situation, the first dummy pixel group DPG1 shown in FIG. 13 displays a black image.

When a specific image (hereinafter referred to as a protection image) is displayed as described above, if an orbit driving method is used to move the position where the protection image is displayed, the subpixels included in the display panel 150 continuously display the same image, and thus the deterioration phenomenon can be delayed. Furthermore, if a dummy pixel group disposed in an outer area is displayed in black in addition to moving the position where the protection image is displayed, the problem that the movement of the position of the protection image is visible on the screen can be prevented or the problem of a luminance difference due to the movement of the position of the protection image can be improved. Also, the pixels around the border of the screen can be given an additional rest period during which black is displayed and a deterioration phenomenon and burn out issues can be delayed, thus increasing the lifespan of the device and improving image quality. This can be especially helpful since logos or static information such as banners are often displayed around the border or edges of the screen.

The light emitting display device according to the embodiment can adopt an adaptive sensing method in response to the phenomenon in which a sensing time for acquiring a sensing voltage increases or decreases based on different driving frequencies. To this end, dummy pixels (or dummy subpixels) included in the dummy pixel groups DPG1 to DPG4 can be used in the embodiment. Hereinafter, an example of a situation in which the position of the protection image displayed on the display panel 150 moves from the top to the bottom, as in the situation of FIG. 15, will be described in the embodiment.

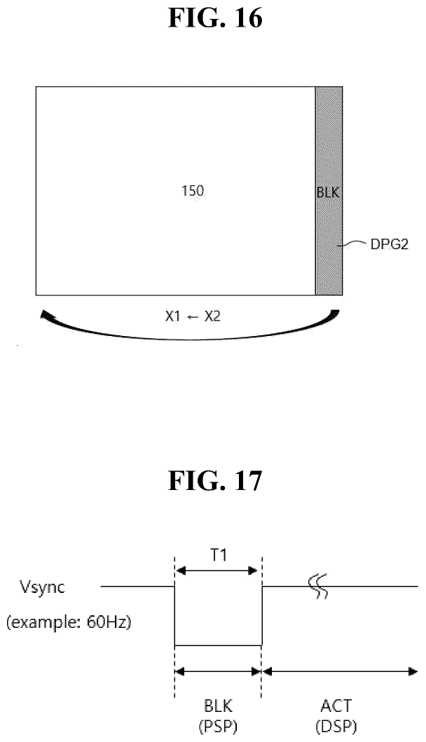

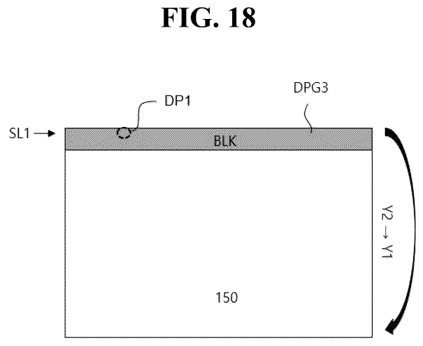

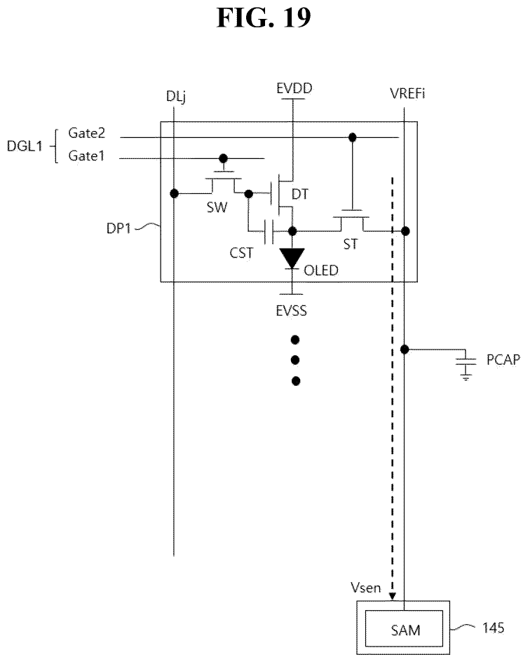

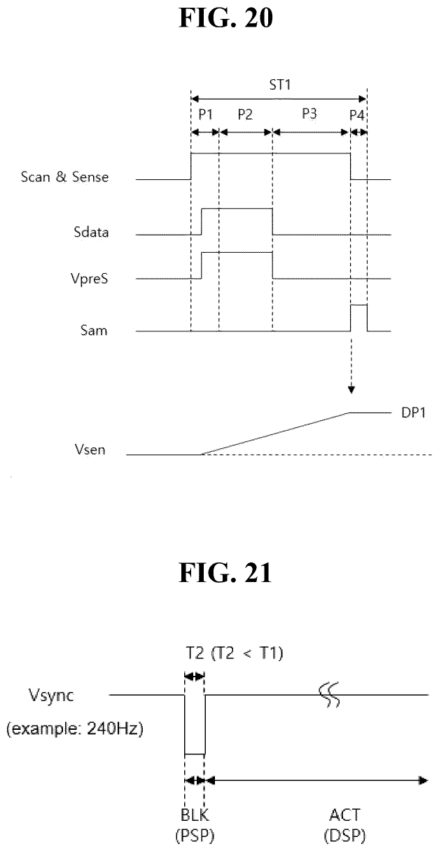

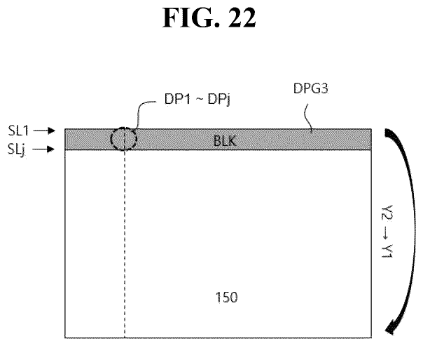

FIG. 17 to FIG. 20 are diagrams illustrating a method of sensing one dummy subpixel included in the display panel at a first frequency according to the embodiment, and FIG. 21 to FIG. 24 are diagrams illustrating a method of sensing a plurality of dummy subpixels included in the display panel at a second frequency according to the embodiment. Hereinafter, the sensing methods according to the embodiment will be described with reference to the internal configuration of the sensing circuit 145 shown in FIG. 10.

As shown in FIG. 10 and FIG. 17 to FIG. 20, the light emitting display device according to the embodiment can display a specific image (e.g., a screen protection image) rather than a general image (e.g., actual input image data) on the display panel 150. When the position of the display image moves from the top (Y2) to the bottom (Y1), the third dummy pixel group DPG3 located in the upper outer area of the display panel 150 can display a black image BLK. In other words, a portion of the actual input image data can be replaced by a screen protection image in a border area of the screen. For example, the screen protection image can include intermediate or low grayscale values or a certain predefined pattern to help equalize voltages and give that area of the screen a rest, but embodiments are not limited thereto.

When the light emitting display device according to the embodiment is driven at the first frequency (e.g., 60 Hz), the first dummy subpixel DP1 can be designated as a sensing target line SL1 in the third dummy pixel group DPG3 displaying the black image BLK by orbit driving. The first dummy subpixel DP1 designated as the sensing target line SL1 can operate in the order of a first period P1 to a fourth period P4 defined in a first sensing time ST1 as follows.

During the first period P1 to the third period P3, a first scan signal and a first sensing signal Scan & Sense of a high voltage (on-voltage) can be applied to the first scan line Gate1 and the second scan line Gate2 of the first dummy subpixel DP1. The first scan signal and the first sensing signal Scan & Sense can be applied as a high voltage during the first period P1 to the third period P3 and then changed to a low voltage (off-voltage) during the fourth period P4.

During the first period P1 and the second period P2, a sensing data voltage Sdata can be applied to the J-th data line DLj of the first dummy subpixel DP1. During the first period P1 and the second period P2, a first voltage circuit control signal VpreS can be applied as a high voltage (on-voltage) and then changed to a low voltage (off-voltage).

During the fourth period P4, the sampling circuit SAM connected to an I-th reference line VREFi of the first dummy subpixel DP1 can be turned on in response to a sampling control signal Sam. The sampling control signal Sam can be applied as a high voltage (on-voltage) during the fourth period P4.

During the first period P1, the sensing node of the driving transistor DT included in the first dummy subpixel DP1 can be initialized by the first reference voltage. During the second period P2, the driving transistor DT of the first dummy subpixel DP1 can operate as a constant current source for a certain period of time by the sensing data voltage Sdata. During the third period P3, the first dummy subpixel DP1 can operate in a current tracking state according to source following of the driving transistor DT. The voltage applied to the sensing node of the first dummy subpixel DP1 during the fourth period P4 can be acquired as a sensing voltage Vsen by the sampling circuit SAM connected to the I-th reference line VREFi.

To summarize the above description, the light emitting display device according to the embodiment can designate only one dummy pixel as a sensing target and sense the same independently when the driving frequency is not high (e.g., 60 Hz) such that a sufficient sensing time can be secured (or when the driving frequency is low enough to secure a sufficient sensing time).

As shown in FIG. 10 and FIG. 21 to FIG. 24, the light emitting display device according to the embodiment can display a specific image (e.g., a screen protection image) rather than a general image on the display panel 150. When the position of the display image moves from the top (Y2) to the bottom (Y1), the third dummy pixel group DPG3 located in the upper outer area of the display panel 150 can display a black image BLK. In other words, when the fourth dummy pixel group DPG4 located in the lower outer area of the display panel 150 is displaying the screen protection image, the third dummy pixel group DPG3 located in the upper outer area of the display panel 150 can display a black image BLK and sensing can be performed on one or more subpixels including the third dummy pixel group DPG3.

When the light emitting display device according to the embodiment is driven at the second frequency (e.g., a higher frequency, such as 240 Hz), the first to J-th dummy subpixels DP1 to DPj can be designated as sensing target lines SL1 to SLj in the third dummy pixel group DPG3 displaying the black image BLK by orbit driving. The first to J-th dummy subpixels DP1 to DPj designated as the sensing target lines SL1 to SLj can operate in the first period P1 to the fourth period P4 defined in a second sensing time ST2 in order as follows. Here, the second sensing time ST2 is shorter than the first sensing time ST1 (e.g., ST2<ST1). For example, when the light emitting display device is driven at a higher frequency, a group of the first to J-th dummy subpixels DP1 to DPj designated as the sensing target lines SL1 to SLj can be sensed together at the same time, since there is less time spent displaying the black image BLK (e.g., the PSP sensing period is shorter).

During the first period P1 to the third period P3, the first scan signal and the first sensing signal Scan & Sense of a high voltage (on-voltage) can be applied to the first scan line Gate1 and the second scan line Gate2 of the first to J-th dummy subpixels DP1 to DPj. The first scan signal and the first sensing signal Scan & Sense can be applied as a high voltage during the first period P1 to the third period P3 and then changed to a low voltage (off-voltage).

During the first period P1 and the second period P2, the sensing data voltage Sdata can be applied to the J-th data line DLj of the first to J-th dummy subpixels DP1 to DPj. During the first period P1 and the second period P2, the first voltage circuit control signal VpreS can be applied as a high voltage (on-voltage) and then changed to a low voltage (off-voltage).

During the fourth period P4, the sampling circuit SAM connected to the I-th reference line VREFi of the first to J-th dummy subpixels DP1 to DPj can be turned on in response to the sampling control signal Sam. The sampling control signal Sam can be applied as a high voltage (on-voltage) only during the fourth period P4.

During the first period P1, the sensing nodes of the driving transistors DT included in the first to J-th dummy subpixels DP1 to DPj can be initialized by the first reference voltage. During the second period P2, the driving transistors DT of the first to J-th dummy subpixels DP1 to DPj can operate as constant current sources for a certain period of time by the sensing data voltage Sdata. During the third period P3, the first to J-th dummy subpixels DP1 to DPj can operate in a current tracking state according to source following of the driving transistors DT. During the fourth period P4, the voltages applied to the sensing nodes of the first to J-th dummy subpixels DP1 to DPj can be summed together by the sampling circuit SAM connected to the I-th reference line VREFi and acquired as a sensing voltage Vsen. In other words, the first to J-th dummy subpixels DP1 to DPj can simultaneously sensed together as a group.

To summarize the above description, when the driving frequency of the light emitting display device according to the embodiment is too high to secure a sufficient amount of sensing time, a plurality of dummy subpixels can be designated as sensing targets and sensed simultaneously. In other words, when the light emitting display device is driven at a higher frequency, a group of dummy subpixels can be sensed together at the same time.

Meanwhile, the light emitting display device according to the embodiment can be implemented to support various driving frequencies in addition to the aforementioned driving frequencies. For example, if the light emitting display device is implemented as a UHD display device capable of operating at 240 Hz, it can support not only a 240 Hz driving mode and a 60 Hz driving mode but also a 120 Hz driving mode. In addition, recently manufactured and implemented light emitting display devices can support a Variable Refresh Rate (VRR) operation such that they can be used adaptively in various driving environments rather than a fixed driving frequency environment.

As can be ascertained through FIG. 17 and FIG. 21, when the driving frequency for driving the display panel is high (e.g., a high frequency, such as 240 Hz), the time for defining the blank period BLK included in the vertical synchronization signal Vsync can be reduced. In other words, if the resolution of the display panel is high (e.g., high resolution) and the driving frequency for driving the display panel is high (e.g., high frequency), the sensing period PSP can be shortened. This can also apply when the driving frequency for driving the display panel is high and the resolution is high (e.g., high resolution).

In this manner, as the blank period BLK becomes shorter, the sensing period PSP also decreases, and thus it can be difficult to determine whether a sensing voltage is acquired as a normal value or an abnormal value.

In order to improve the ability to determine a significant difference, the light emitting display device according to the embodiment can vary the amount of current that can be acquired through sensing in response to a change in a driving frequency and limit sensing targets to just some dummy subpixels. Additionally, the number of sensing target dummy subpixels can be increased or decreased in order to vary the amount of current in response to change in the driving frequency. That is, the light emitting display device according to the embodiment can vary the amount of acquired current by increasing or decreasing the number of sensing target dummy subpixels in response to change in the driving frequency (in other words, change in the blank period) in order to improve the ability to determine a significant difference.

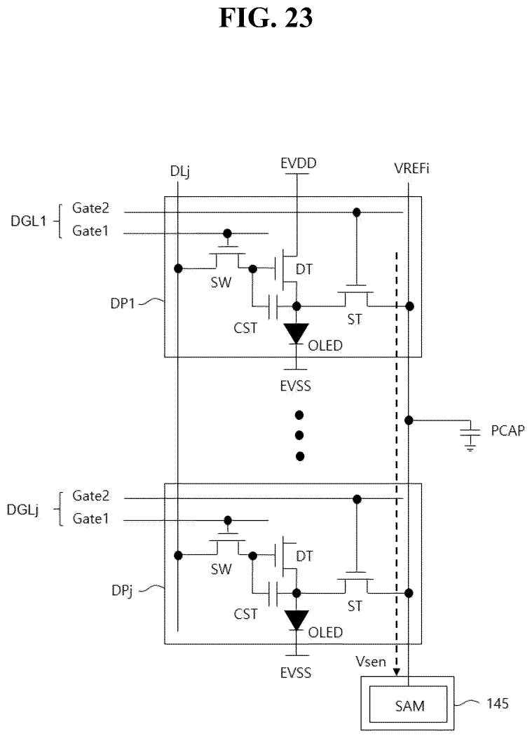

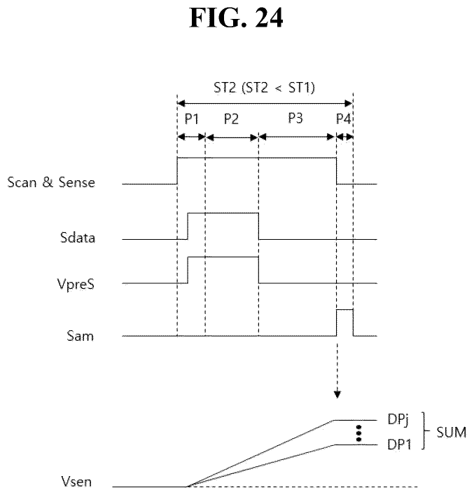

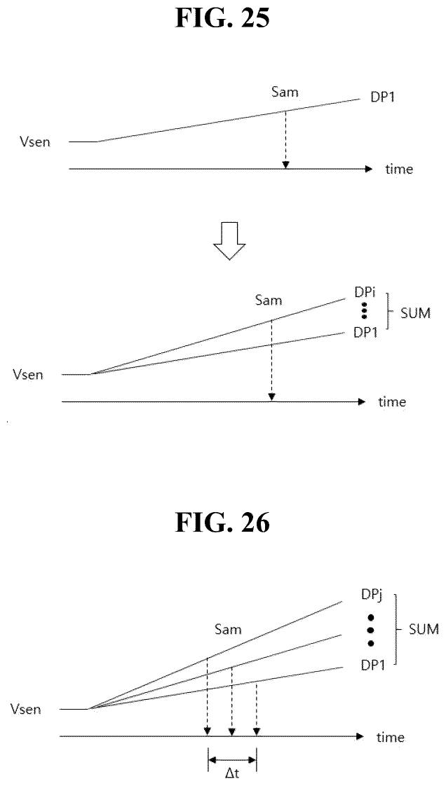

FIG. 25 to FIG. 27 are diagrams illustrating changes in driving timing when an adaptive sensing method is adopted in response to a frequency change according to an embodiment.

As shown in FIG. 25 and FIG. 26, the amount of current can be increased when summing the amounts of current acquired from the plurality of dummy subpixels DP1 to DPj rather than acquiring the current from one dummy subpixel DP1. In addition, assuming that the same target current amount is acquired, sensing time Δt can be reduced when summing the amounts of current acquired from the plurality of dummy subpixels DP1 to DPj rather than acquiring the current from just one dummy subpixel DP1.

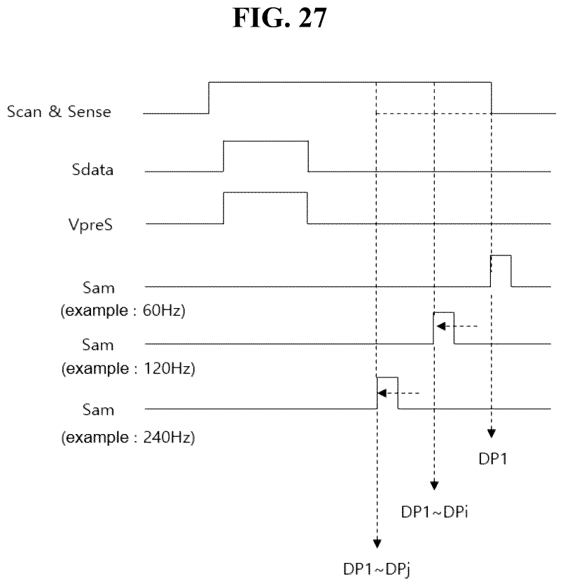

As shown in FIG. 27, the light emitting display device according to the embodiment can vary the amount of acquired current by increasing or decreasing the number of sensing target dummy subpixels in response to a change in the driving frequency (in other words, a change in the blank period). For example, if the driving frequency is lower than a reference driving frequency of 120 Hz, such as 60 Hz, only the first dummy subpixel DP1 can be sensed upon determining that the driving frequency is sufficient to secure enough sensing time. However, if the driving frequency is higher than the reference driving frequency of 120 Hz, such as 240 Hz, a group of dummy subpixels DP1 to DPj can be sensed together upon determining that the driving frequency cannot secure sufficient sensing time.

An example in which the reference driving frequency of the light emitting display device is set to 120 Hz has been described above. However, the reference driving frequency can be set based on the lowest and highest driving frequencies of the implemented light emitting display device, or a driving frequency that causes insufficient sensing time can be set as the reference driving frequency.

As can be ascertained by referring to the illustrated example, according to the embodiment, the time for applying the sensing data voltage Sdata and the time for applying the first reference voltage (refer to VpreS, which allows application of the first reference voltage) can be fixed without being changed. However, the first scan signal Scan, the first sensing signal Sense, and the sampling control signal Sam for determining the sensing time can vary depending on the number of sensing target dummy subpixels. This can be ascertained by comparing a situation where one dummy subpixel DP1 is sensed, a situation where the first to I-th dummy subpixels DP1 to Dpi are sensed, and a situation where the first to J-th dummy subpixels DP1 to DPj are sensed.

In other words, the sensing time decreases as the driving frequency increases, and thus the number of sensing target dummy subpixels can be increased such that the amount of current that can be acquired during a limited amount of time increases.

Meanwhile, as in the embodiment, the method of acquiring a sensing voltage using dummy subpixels included in the display panel capable of orbit driving and varying the number of sensing target dummy subpixels in response to change in the driving frequency can provide greater advantages than the method of sensing subpixels disposed in the display area of the display panel.

For example, if the driving frequency becomes higher than the aforementioned reference frequency (e.g., 120 Hz), the sensing time decreases, and thus it can be difficult to acquire a sensing voltage from subpixels disposed in the display area of the display panel as a significant value within a limited time (blank period). However, the dummy subpixels included in the display panel display black for a certain period of time in response to the movement of the position of a protection image during orbit driving, and thus the number of sensing target dummy subpixels can be selectively varied in response to a change in the driving frequency and a sensing voltage can be obtained therefrom. In addition, since a group of dummy subpixels included in the display panel can be sensed together at time same time during orbit driving, a sensing voltage can be obtained as a significant value compared to a situation of obtaining a sensing voltage from the subpixels disposed in the display area of the display panel. Furthermore, this method can also be used when the subpixels disposed in the display area of the display panel cannot be sensed or the subpixels disposed in the display area of the display panel are implemented as subpixels that cannot be sensed (e.g., sensingless subpixels).

The light emitting display device according to the embodiment can obtain a sensing voltage from dummy subpixels included in the display panel during orbit driving and detect the presence or absence of a defect in the display panel based on the sensing voltage, which will be described below.

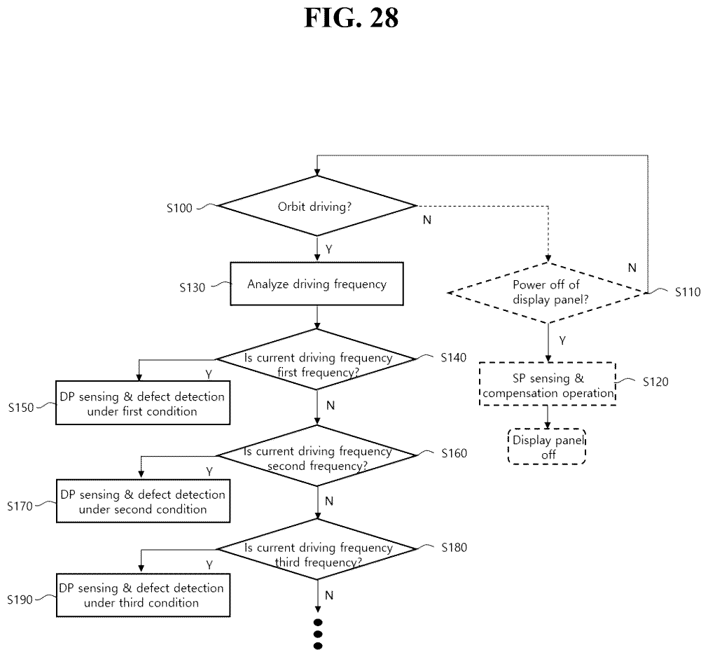

FIG. 28 is a flowchart illustrating a method of driving the light emitting display device according to an embodiment.

As shown in FIG. 28, the light emitting display device according to the embodiment can determine whether orbit driving of the display panel is being performed (S100). If orbit driving of the display panel is not performed (N), it can be determined whether a power-off signal of the display panel is applied (S110). If the power-off signal of the display panel is applied (Y), a sensing voltage can be acquired by sensing the subpixels SP disposed in the display area of the display panel, and a compensation operation for compensating for deterioration can be performed based on the sensing voltage (S120). If the sensing and compensation operations of the subpixels SP are completed, the display panel can be turned off.

On the other hand, if orbit driving of the display panel is being performed (Y), the driving frequency can be analyzed (S130). If the current driving frequency is a first frequency (Y), a sensing voltage can be acquired by sensing a dummy subpixel DP of the display panel under a first condition, and the presence or absence of a defect in the display panel can be detected based on the sensing voltage (S150). For example, the first frequency can be a low frequency, such as 60 Hz, and the first condition can be a condition in which a sensing voltage is acquired by sensing one dummy subpixel (e.g., sensing one subpixel at a time).

If the current driving frequency is not the first frequency (N), it can be determined whether the current driving frequency is a second frequency (S160). If the current driving frequency is the second frequency (Y), a sensing voltage can be acquired by sensing a group of dummy subpixels DP together (e.g., sensing one line or one row of subpixels) under a second condition, and the presence or absence of a defect in the display panel can be detected based on the sensing voltage (S170). For example, the second frequency can be a medium or intermediary frequency, such as 120 Hz, and the second condition can be a condition in which a sensing voltage is acquired by sensing more dummy subpixels than those in the first condition and fewer than those in a third condition.

If the current driving frequency is not the second frequency (N), it can be determined whether the current driving frequency is a third frequency (S180). If the current driving frequency is the third frequency (Y), a sensing voltage can be acquired by sensing a larger group of dummy subpixels DP of the display panel under a third condition, and the presence or absence of a defect in the display panel can be detected based on the sensing voltage (S190). For example, the third frequency can be a high driving frequency, such as 240 Hz, and the third condition can be a condition in which a sensing voltage is acquired by sensing a larger number of dummy subpixels than in the second condition (e.g., simultaneously sensing multiple lines or multiple rows of subpixels together).

As described above, when orbit driving of the display panel is being performed, the light emitting display device according to the embodiment can analyze the driving frequency, selectively change the number of sensing target dummy subpixels in response to the current driving frequency, obtain a sensing voltage (sensing value) based thereon, and detect the presence or absence of a defect in the display panel and the location (coordinates) of the defect based on the sensing voltage. In other words, the light emitting display device can dynamically change how many subpixels are to be sensed during one blank period BLK (e.g., sensing period PSP) based on the driving frequency. For example, when the light emitting display device is being driven at a low frequency (e.g., 60 Hz), then the light emitting display device can perform sensing of one subpixel at a time, or sequentially sensing one line at a time. Also, when the light emitting display device is being driven at an intermediary frequency (e.g., 120 Hz), then the light emitting display device can perform simultaneous sensing of a group of subpixels at a same time (e.g., sensing one row of subpixels together). Further, when the light emitting display device is being driven at a high frequency (e.g., 240 Hz), then the light emitting display device can perform simultaneous sensing of a larger group of subpixels at a same time (e.g., sensing multiple rows or lines of subpixels together). Also, when simultaneously sensing multiple subpixels at the same time, the sensing values can be summed together and the summation can be compared to a predetermined value to determine whether or not a defect is present.

A defect in the display panel can be determined based on the sensing voltage and can include a line defect caused by a defect in data lines/gate lines included in the display panel (which can be determined when a sensing value error occurs/when a sensing value cannot be obtained), a defect in a power supply and a power line, or an error output therefrom (which can be determined when a sensing value cannot be obtained), short-circuit between signal lines or power lines included in the display panel, overcurrent (burn-in due to overcurrent) caused by the short-circuit, and the like.

As described above, the present disclosure has the effect of solving the problem of securing a sensing time (difficulty in sensing during a short blank period while the display panel is driven) that can occur in a high-resolution and high-frequency driving environment. In addition, the present disclosure has the effect of solving the problem of securing a sensing time by increasing or decreasing the number of sensing target dummy subpixels in response to change in a driving frequency during orbital driving of the display panel. Additionally, the present disclosure has the effect of detecting the presence or absence of a defect in the display panel by increasing or decreasing the number of dummy subpixels.

It will be apparent to those skilled in the art that various modifications and variations can be made in the present disclosure without departing from the spirit or scope of the present disclosure. Thus, it is intended that the present disclosure cover the modifications and variations of the present disclosure provided they come within the scope of the appended claims and their equivalents.

What is claimed is:

1. A display device comprising:
a display panel including subpixels disposed in a display area and dummy subpixel lines disposed in an outer area of the display area; and
a circuit configured to:
output a data voltage for driving the display panel during a first period and acquire a sensing value from the display panel during a second period, and
in response to a change of a driving frequency of the display panel, increase or decrease a number of sensing target dummy subpixel lines among the dummy subpixel lines to sense during the second period.

2. The display device of claim 1, wherein the circuit is further configured to increase the number of sensing target dummy subpixel lines when the driving frequency increases.

3. The display device of claim 1, wherein the circuit is further configured to:
set a reference driving frequency of the display panel,
increase the number of sensing target dummy subpixel lines when the driving frequency becomes higher than the reference driving frequency, and
decrease the number of sensing target dummy subpixel lines when the driving frequency becomes lower than the reference driving frequency.

4. The display device of claim 1, wherein the circuit is further configured to select a dummy subpixel line displaying black during a blank period as a sensing target when a position of an image displayed on the display panel moves up, down, left, or right.

5. The display device of claim 1, wherein the circuit is further configured to determine that the display panel has a defect based on the sensing value obtained from the number of the sensing target dummy subpixel lines.

6. The display device of claim 1, wherein the circuit is further configured to:
supply a sensing data voltage through a dummy data line connected to at least one of the dummy subpixel lines during the blank period of the display panel, and
receive the sensing value through a reference line connected to the at least one of the dummy subpixel lines.

7. A method of driving a display device, the method comprising:
displaying a protection image by subpixels disposed in a display area of a display panel and moving a position where the protection image is displayed;
displaying a black image on at least one of dummy subpixel lines disposed in an outer area of the display panel and moving a position of the black image when the display position of the protection image is moved; and
selecting one or more dummy subpixel lines displaying black among the dummy subpixel lines as a sensing target when the position of the image displayed on the display panel moves up, down, left, or right, and sensing the sensing target.

8. The method of claim 7, further comprising:
changing a number of the one or more dummy subpixel lines to sense as the sensing target based on a change in a driving frequency of the display panel.

9. The method of claim 8, wherein the sensing of the sensing target includes increasing the number of the one or more dummy subpixel lines to sense when the driving frequency of the display panel increases.

10. The method of claim 7, further comprising:
determining that the display panel has a defect based on a sensing value obtained from the sensing target.

11. The method of claim 7, wherein the sensing of the sensing target is performed during a blank period of the display panel.

12. A display device comprising:
a display panel including a plurality of subpixels configured to display an image, the plurality of subpixels including dummy subpixels disposed in a border area of the display panel; and
a controller configured to:
in response to driving the display panel at a first driving frequency, sense a voltage corresponding to one dummy subpixel from among the dummy subpixels during a blank period, and
in response to driving the display panel at a second driving frequency higher than the first driving frequency, sense voltages corresponding to a first number of dummy subpixels from among the dummy subpixels during the blank period.

13. The display device of claim 12, wherein the controller is further configured to:
in response to driving the display panel at a third driving frequency higher than the first and second driving frequencies, sense voltages corresponding to a second number of dummy subpixels from among the dummy subpixels during the blank period,
wherein the second number of subpixels is greater than the first number of subpixels.

14. The display device of claim 13, wherein the first driving frequency is 60 Hz, the second driving frequency is 120 Hz, and the third driving frequency is 240 Hz.

15. The display device of claim 12, wherein the dummy subpixels include a first group of dummy subpixels disposed at a left outer area of the display panel, a second group of dummy subpixels disposed at a right outer area of the display panel, a third group of dummy subpixels disposed at an upper outer area of the display panel, and a fourth group of dummy subpixels disposed at a lower outer area of the display panel,
wherein the controller is further configured to:
display a screen protection image by at least one group among the first, second, third and fourth groups of dummy subpixels based on an orbit driving manner.

16. The display device of claim 15, wherein the controller is further configured to:
in response to moving the screen protection image from the third group of dummy subpixels to the fourth group of dummy subpixels, display black by the third group of dummy subpixels during the blank period and sensing a voltage corresponding to at least one dummy subpixel among the third group of dummy subpixels during the blank period, and
perform a compensation operation or determine that the display panel has a defect based on the voltage corresponding to the at least one dummy subpixel among the third group of dummy subpixels.

17. The display device of claim 15, wherein the controller is further configured to:
in response to driving the display panel at the first driving frequency, select a single dummy subpixel as the at least one dummy subpixel among the third group of dummy subpixels to be sensed during the blank period, and
in response to driving the display panel at the second driving frequency or the third driving frequency, select one or more lines of dummy subpixels as the at least one dummy subpixel among the third group of dummy subpixels to be sensed during the blank period.

18. The display device of claim 17, wherein the controller is further configured to:
sum voltage values corresponding to the one or more lines of dummy subpixels to generate a summation value, and
perform the compensation operation or determine that the display panel has the defect based of the summation value.

19. The display device of claim 15, wherein the controller is further configured to:
in resonse to moving the screen protection image from the second group of dummy subpixels to the first group of dummy subpixels, display black by the second group of dummy subpixels during the blank period and sense a voltage corresponding to at least one dummy subpixel among the second group of dummy subpixels during the blank period, and
perform a compensation operation or determining that the display panel has a defect based on the voltage corresponding to the at least one dummy subpixel among the second group of dummy subpixels.

20. The display device of claim 12, wherein the controller is further configured to:
supply a sensing data voltage to a datal line connected to the one dummy subpixel or one of the first number of dummy subpixels during the blank period, and
receive a sensing value from a reference line connected to the one dummy subpixel or the one of the first number of dummy subpixels during the blank period.
